(19) United States
(12) Patent Application Publication
(10) Pub. No.: US 2013/0297608 A1
(43) Pub. Date: Nov. 7, 2013

(54) CONTENT PRESENTATION DEVICE, CONTENT PRESENTATION TERMINAL, CONTENT PRESENTATION SYSTEM, CONTENT PRESENTATION PROGRAM, AND CONTENT PRESENTATION METHOD

(71) Applicant: PANASONIC CORPORATION, Osaka (JP)

(72) Inventors: Hiroki ETOH, Osaka (JP); Haruka KAWANISHI, Kanagawa (JP); Keiko ANDO, Kanagawa (JP)

(21) Appl. No.: 13/937,131

(22) Filed: Jul. 8, 2013

Related U.S. Application Data
(63) Continuation of application No. PCT/JP2012/004353, filed on Jul. 5, 2012.

(30) Foreign Application Priority Data
Feb. 15, 2012 (JP) 2012-030277

(51) Int. Cl. G06F 17/30

(52) U.S. Cl. CPC G06F 17/30595
USPC 707/737; 707/752

(57) ABSTRACT

A content presentation device including: an obtaining unit which obtains a preference of a first user, a preference of a second user, content identification information identifying a plurality of content items associated with the second user, and relationship information indicating a relationship between the first user and the second user; a content evaluating unit which evaluates display of each of the content items, based on the relationship information and a preference correlation between the preference of the first user and the preference of the second user, wherein the content evaluating unit gives a high evaluation to a content item associated with the second user, the content item having the preference correlation lower than a certain preference correlation and an affinity score higher than a certain affinity score, and the affinity score indicating strength of the relationship between the first user and the second user.

### CROSS REFERENCE TO RELATED APPLICATIONS

This is a continuation application of PCT International Application No. PCT/JP2012/004353 filed on Jul. 5, 2012, designating the United States of America, which is based on and claims priority of Japanese Patent Application No. 2012-030277 filed on Feb. 15, 2012. The entire disclosures of the above-identified applications, including the specifications, drawings and claims are incorporated herein by reference in their entirety.

### FIELD

The present disclosure relates to a content presentation device, a content presentation system, a content presentation program, and so on for presenting a content item recommended for a user.

### BACKGROUND

Services that provide users with various content items such as music, video, electronic books, news articles, product information, and event information have gained in popularity. In contrast, the number of the content items is dramatically increasing, and excessive numbers of currently available television channels, viewing content items, electronic books, event information items, and so on make it difficult for the users to independently search and select a content item.

For this reason, recommendation services and so on in which a system recommends a suitable content item to a user have been provided. As an example of a recommendation service that recommends a content item to a user, a method called collaborative filtering in which a content item previously used by another user is presented has been disclosed (see, Patent Literature (PTL) 1, for instance). Here, the content item used by the other user is the same as a content item used by the user. The collaborative filtering has been adopted in many content recommendation services.

Moreover, the spread of the Internet has made it possible to use social networks online. For example, a social networking service such as Facebook (registered trademark) and Mixi (registered trademark) has offered a common place for users to have communication such as dialogue online with family members, friends, acquaintances, colleagues, and related persons of the users. The users can post, on such a social networking service, various information such as names, schools, groups in big cities, events, activities, hobbies, and favorite books, music, and video, and share the various information with other users.

Furthermore, as another example of the recommendation service that recommends a content item to a user, a method for presenting a content item or an advertisement based on information about human relationships of a user accumulated in a social networking service has been disclosed (see Patent Literature (PTL) 2, for instance). PTL 2 discloses a method for presenting a content item (advertisement information) having a high level of interest of a related person in order of decreasing affinity score of the related person with the user.

### CITATION LIST

### Patent Literature

[PTL 1] U.S. Pat. No. 6,064,980 Specification

[PTL 2] International Publication WO 2008/059692

### Non Patent Literature

### SUMMARY

### Technical Problem

It is to be noted that when providing a content recommendation service, it is desirable to present, to a user, not only a content item in a genre related to an actual preference (e.g., a content item in a genre having a relatively large number of usage history records) of the user but also a content item in a genre related to a potential preference (e.g., a content item in a genre which has no usage history records but the user may be potentially interested in) of the user.

However, the above method described in PTL 1 rests on a presumption that a content item used by another user having similar preferences is a content item actually preferred by a user, and a content item to be presented is prone to be fixed to a content item in a genre related to an actual preference of the user.

Moreover, an advertisement (a content item) is selected based only on the affinity scores indicating strength of relationships between the user and related persons in the above method described in PTL 2, and thus a genre of a content item to be presented and so on is not considered. Consequently, although the method described in PTL 2 makes it possible to present a content item in a genre related to a potential preference of the user, the presentation is not sufficiently accurate.

The present disclosure provides a content presentation device, a content presentation terminal, a content presentation system, and a content presentation program that make it possible to more accurately present a content item related to a potential preference of a user.

### Solution to Problem

In order to solve the above problems, a content presentation device according to an aspect of the present disclosure includes: an obtaining unit configured to obtain first preference information indicating a preference of a first user, second preference information indicating a preference of a second user, content identification information identifying a plurality of content items associated with the second user, and relationship information indicating a relationship between the first user and the second user; a content evaluating unit configured to evaluate display of each of the content items identified by the content identification information, based on the relationship information and a preference correlation between the preference indicated by the first preference information and the preference indicated by the second preference information; and an output unit configured to output evaluation information indicating a result of the evaluation performed by the content evaluating unit, wherein the content evaluating unit is configured to give a high evaluation to at least one of the content items associated with the second user, the at least one content item having the preference correlation lower than a certain preference correlation and a affinity score higher than a certain affinity score, and the affinity score indicating strength of the relationship between the first user and the second user indicated by the relationship information.

In order to solve the above problems, a content presentation terminal according to another aspect of the present disclosure includes: a receiving unit configured to receive the evaluation information from the output unit of the above content presentation device; and a display unit configured to display the at least one content item along a preference axis indicating strength of the preference correlation with the first user, based on the evaluation information, and place display of the second user in a display region defined by the preference axis and an affinity axis indicating the affinity score with the first user.

In order to solve the above problems, a content presentation system according to a further aspect of the present disclosure includes: a content presentation device including: an obtaining unit configured to obtain first preference information indicating a preference of a first user, second preference information indicating a preference of a second user, content identification information identifying a plurality of content items associated with the second user, and relationship information indicating a relationship between the first user and the second user; a content evaluating unit configured to evaluate display of the content items identified by the content identification information, based on the relationship information and a preference correlation between the preference indicated by the first preference information and the preference indicated by the second preference information; and an output unit configured to output evaluation information indicating a result of the evaluation performed by the content evaluating unit, wherein the content evaluating unit is configured to give a high evaluation to at least one of the content items associated with the second user, the at least one content item having the preference correlation lower than a certain preference correlation and an affinity score higher than a certain affinity score, and the affinity score indicating strength of the relationship between the first user and the second user indicated by the relationship information; and a content presentation terminal including: a receiving unit configured to receive the evaluation information from the output unit of the content presentation device; and a display unit configured to display the at least one content item along a preference axis indicating strength of the preference correlation with the first user, based on the evaluation information.

In order to solve the above problems, a non-transitory computer-readable recording medium according to still another aspect of the present disclosure, the recording medium having a content presentation program recorded thereon for causing a computer to evaluate display of a content item, wherein the content presentation program includes: obtaining first preference information indicating a preference of a first user, second preference information indicating a preference of a second user, content identification information identifying a plurality of content items associated with the second user, and relationship information indicating a relationship between the first user and the second user; evaluating display of each of the content items identified by the content identification information, based on the relationship information and a preference correlation between the preference indicated by the first preference information and the preference indicated by the second preference information; and outputting evaluation information indicating a result of the evaluation performed in the evaluating, wherein in the evaluating, at least one of the content items associated with the second user is given to a high evaluation, the at least one content item having the preference correlation lower than a certain preference correlation and an affinity score higher than a certain affinity score, and the affinity score indicating strength of the relationship between the first user and the second user indicated by the relationship information.

In order to solve the above problems, a content presentation method according to yet another aspect of the present disclosure includes: obtaining first preference information indicating a preference of a first user, second preference information indicating a preference of a second user, content identification information identifying a plurality of content items associated with the second user, and relationship information indicating a relationship between the first user and the second user; evaluating display of each of the content items identified by the content identification information, based on the relationship information and a preference correlation between the preference indicated by the first preference information and the preference indicated by the second preference information; and outputting evaluation information indicating a result of the evaluation performed in the evaluating, wherein in the evaluating, at least one of the content items associated with the second user is given to a high evaluation, the at least one content item having the preference correlation lower than a certain preference correlation and an affinity score higher than a certain affinity score, and the affinity score indicating strength of the relationship between the first user and the second user indicated by the relationship information.

### Advantageous Effects

A content presentation device in the present disclosure makes it possible to more accurately present a content item related to a potential preference of a user.

### BRIEF DESCRIPTION OF DRAWINGS

These and other objects, advantages and features of the invention will become apparent from the following description thereof taken in conjunction with the accompanying drawings that illustrate a specific embodiment of the present invention.

FIG. 1 is an external view of a content presentation system.

FIG. 2 is a block diagram showing an exemplary configuration of each of servers included in the content presentation system in Embodiment 1.

FIG. 3 is a table showing, as relationship information, history records of communication between a user and the user's related persons.

FIG. 4 is a table showing exemplary check-in information.

FIG. 5 is a table showing exemplary viewing history information of TV content items viewed by a user.

FIG. 6 is a table showing exemplary metadata of TV content items.

FIG. 7 is a diagram showing an exemplary user interface in Embodiment 1.

FIG. 8 is a flow chart showing operation of a content presentation server in Embodiment 1.

FIG. 9 is a flow chart showing a method for calculating affinity score ranking in Embodiment 1.

FIG. 10 is a flow chart showing a method for calculating preference ranking in Embodiment 1.

FIG. 11A is a table showing exemplary data in a process of calculating preference vectors in Embodiment 1.

FIG. 11B is a table showing exemplary data in a process of calculating preference vectors in Embodiment 1.

FIG. 11C is a table showing exemplary data in a process of calculating preference vectors in Embodiment 1.

FIG. 12 is a flow chart showing a method for evaluating a content item in Embodiment 1.

FIG. 13 is a block diagram showing an exemplary configuration of each of servers included in a content presentation system in Embodiment 2.

FIG. 14 is a table showing exemplary metadata of event content items.

FIG. 15 is a diagram showing an exemplary user interface in Embodiment 2.

FIG. 16 is a flow chart showing a method for evaluating a content item in Embodiment 2.

FIG. 17 is a diagram showing an exemplary user interface in Embodiment 2.

### DESCRIPTION OF EMBODIMENTS

### Embodiment 1

(Circumstances Leading to an Aspect of the Present Disclosure)

Related persons (second users) such as friends and family members may prefer content items related to potential preferences of a user, that is, preference groups accepted by the user among preference groups having no previous content usage history records. In particular, when related persons having strong relationships with a user such as close friends and family members have different preferences from those of the user, the user often unexpectedly accepts such preferences.

Moreover, when a content item is an event content item, a content item never used by a related person rather than a content item previously used by the related person meets the needs of the user, that is, may be a content item related to a potential preference of the user.

However, as stated above, because the method of PTL 1 presents a content item used by the other user having similar preferences, the presented content item is likely to be fixed to a content item in a field related to an actual preference of the user, and it is difficult to present a content item related to a potential preference of the user. In addition, the method of PTL 1 fails to present, among event content items, a content item never used by a related person.

Moreover, because the method described in PTL 2 determines a content item to be presented, based only on an affinity score, a device fails to predict in which genre (a classification condition) of a content item the content item to be actually presented would be. Furthermore, although the method described in PTL 2 presents a content item associated with a related person and selected based on an affinity score, because it is generally considered that users having similar preferences frequently communicate with each other, it is highly likely to select only the related persons having similar preferences. It is highly likely to preferentially select a content item related to an actual preference of a user when the related person having the similar preferences is selected, and thus it is difficult to present a content item in a genre related to a potential preference of the user. In addition, a content item is presented based on usage histories of the related persons in the case of PTL 2, and thus it is not possible to present, among event content items, a content item never used by the related persons.

In order to solve the above problems, a content presentation device according to an aspect of the present disclosure includes: an obtaining unit configured to obtain first preference information indicating a preference of a first user, second preference information indicating a preference of a second user, and content identification information identifying a plurality of content items associated with the second user; a content evaluating unit configured to evaluate display of each of the content items identified by the content identification information, based on a preference correlation between the preference indicated by the first preference information and the preference indicated by the second preference information; and an output unit configured to output evaluation information indicating a result of the evaluation performed by the content evaluating unit.

The content presentation device directly evaluates the content items based on the preference correlations, and thus makes it possible to determine whether or not the content items are content items each of which has a far preference distance and is highly likely to be a content item related to a potential preference. As a result, a content presentation terminal that receives the evaluation information from the content presentation device makes it possible to more accurately present the content item related to the potential preference of a user (the first user). In addition, the content presentation device evaluates display of the content items based on the preference correlations, and thus makes it possible to present an event content item previously never used (having a far preference distance).

It is to be noted that the first user indicates an individual or a group, and the second user indicates one or more individuals or one or more groups. The content identification information may be information identifying content items for second users as a whole, and may not need to identify the content items for a single second user.

Moreover, for instance, the obtaining unit is further configured to obtain relationship information indicating a relationship between the first user and the second user, and the content evaluating unit is configured to perform the evaluation based on an affinity score in addition to the preference correlation, the affinity score indicating strength of the relationship between the first user and the second user.

Furthermore, for example, the content evaluating unit is configured to perform the evaluation using, as a display target, a content item whose affinity score is high and preference correlation is low, among the content items.

Moreover, for instance, the content evaluating unit is configured to perform the evaluation by increasing a priority level of display of a content item whose affinity score is high and preference correlation is low, among the content items.

Furthermore, for example, the obtaining unit is configured to obtain, as the second preference information, second history information indicating a content item used by the second user, and the content evaluating unit is configured to perform the evaluation using, as a display target, a content item not stored as the second history information.

Moreover, for instance, the obtaining unit is configured to obtain, as the second preference information, second history information indicating a content item used by the second user, and the content evaluating unit is configured to perform the evaluation by increasing a priority level of display of a content item not stored in the second history information.

Furthermore, for example, the obtaining unit is further configured to obtain location information of the at least one content item, and the content evaluating unit is configured to perform, using, as an evaluation target content item, a content item among the content items identified by the content identification information, the evaluation on the evaluation target content item, the content item having a distance between a current location of the first user and a location indicated by the location information of the at least one content item less than a predetermined distance.

Moreover, for instance, the obtaining unit is further configured to obtain time information of the at least one content item, and the content evaluating unit is configured to perform, using, as an evaluation target content item, a content item among the content items identified by the content identification information, the evaluation on the evaluation target content item, the content item having a difference between a current time and the time information of the at least one content item less than a predetermined value.

Furthermore, for example, the content evaluating unit is configured to classify a plurality of the second users into related-person groups based on strength of a plurality of the preference correlations, determine, for each of the relation-person groups, part of the content items identified by the content identification information, as evaluation target content items, based on a plurality of the second preference information items, and perform the evaluation on the evaluation target content items.

Moreover, for instance, the content evaluating unit is configured to calculate the preference correlation using cosine similarity.

Furthermore, for example, each of the first preference information and the second preference information is information indicating a preference for each of genres, the obtaining unit is further configured to obtain the genres of the respective content items, and the content evaluating unit is configured to perform the evaluation, based on the genres of the respective content items in addition to the preference correlation.

In order to solve the above problems, a content presentation terminal according to another aspect of the present disclosure includes: a receiving unit configured to receive the evaluation information from the output unit of the above content presentation device; and a display unit configured to display the at least one content item along a preference axis indicating strength of the preference correlation with the first user, based on the evaluation information, and place display of the second user in a display region defined by the preference axis and an affinity axis indicating the affinity score with the first user.

In order to solve the above problems, a content presentation system according to a further aspect of the present disclosure includes: a content presentation device including: an obtaining unit configured to obtain first preference information indicating a preference of a first user, second preference information indicating a preference of a second user, and content identification information identifying a plurality of content items associated with the second user; a content evaluating unit configured to evaluate display of the content items identified by the content identification information, based on a preference correlation between the preference indicated by the first preference information and the preference indicated by the second preference information; and an output unit configured to output evaluation information indicating a result of the evaluation performed by the content evaluating unit; and a content presentation terminal including: a receiving unit configured to receive the evaluation information from the output unit of the content presentation device; and a display unit configured to display the at least one content item along a preference axis indicating strength of the preference correlation with the first user, based on the evaluation information.

Moreover, the output unit is configured to transmit, to the content presentation terminal, the relationship information obtained by the obtaining unit, in addition to the evaluation information, the receiving unit is configured to receive the evaluation information and the relationship information from the output unit of the content presentation device, and the display unit is configured to place display of the second user in a display region defined by the preference axis and an affinity axis indicating the affinity score with the first user.

In order to solve the above problems, a non-transitory computer-readable recording medium according to still another aspect of the present disclosure, the recording medium having a content presentation program recorded thereon for causing a computer to evaluate display of a content item, wherein the content presentation program includes: obtaining first preference information indicating a preference of a first user, second preference information indicating a preference of a second user, and content identification information identifying a plurality of content items associated with the second user; evaluating display of each of the content items identified by the content identification information, based on a preference correlation between the preference indicated by the first preference information and the preference indicated by the second preference information; and outputting evaluation information indicating a result of the evaluation performed in the evaluating.

In order to solve the above problems, a content presentation method according to yet another aspect of the present disclosure includes: obtaining first preference information indicating a preference of a first user, second preference information indicating a preference of a second user, and content identification information identifying a plurality of content items associated with the second user; evaluating display of each of the content items identified by the content identification information, based on the relationship information and a preference correlation between the preference indicated by the first preference information and the preference indicated by the second preference information; and outputting evaluation information indicating a result of the evaluation performed in the evaluating.

The following describes in detail certain exemplary embodiments of the present disclosure with reference to the drawings. It is to be noted that each of the exemplary embodiments described below shows a specific example of the present disclosure. The structural elements, the arrangement and connection of the structural elements, steps, the processing order of the steps etc. shown in the following exemplary embodiments are mere examples, and therefore do not limit the scope of the appended Claims and their equivalents. Therefore, among the structural elements in the following exemplary embodiments, structural elements not recited in any one of the independent claims are described as arbitrary structural elements.

### Embodiment 1

The following describes a content presentation system according to Embodiment 1 with reference to the drawings. In this embodiment, described is a method for presenting a viewing content item to a user.

Here, in this embodiment, examples of the viewing content item include a video content item that is stream-distributed such as a TV content item, a moving image content item, a music content item, and a movie content item, an advertisement content item showing information such as book information, shop information, event information, and ticket information, and so on. It is to be noted that the viewing content item is not limited to the video content item and the advertisement content item.

(1. Structure)

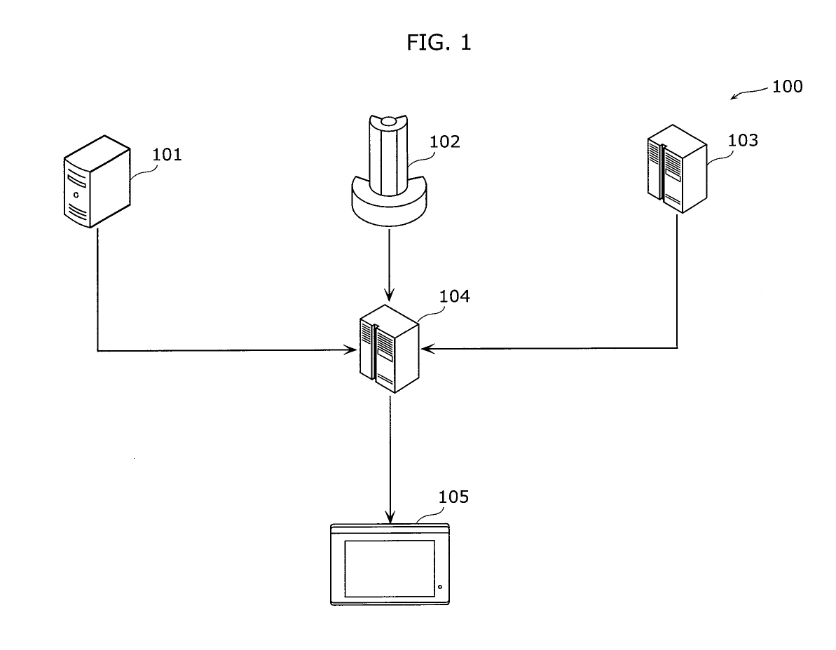

First, the following describes a structure of a content presentation system according to this embodiment with reference to FIG. 1 to FIG. 7.

FIG. 1 is a conceptual diagram showing a structure of a content presentation system 100 in this embodiment.

As shown in FIG. 1, the content presentation system 100 includes: a relationship information management server 101 that manages, for each user, relationship information between the user (a first user) and each of related persons (second users); a preference information management server 102 that manages, for each user, preference information; a content management server 103 that manages content items; a content presentation server 104 that evaluates, based on relationship information and preference information, content items to be presented to a content presentation target user to which the content items are presented; and a content presentation terminal 105 that presents the content items to the content presentation target user.

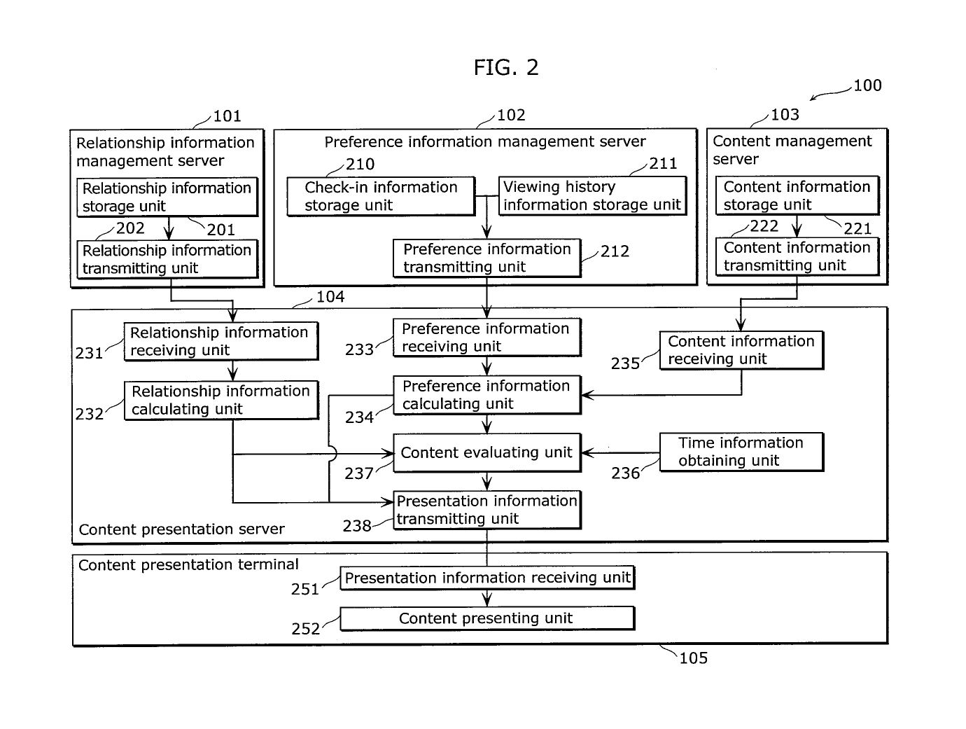

FIG. 2 is a block diagram showing a configuration of each of the servers included in the content presentation system 100.

The relationship information management server 101 provides social networking services, and includes a relationship information storage unit 201 and a relationship information transmitting unit 202.

The relationship information storage unit 201 stores relationship information. In this embodiment, the relationship information includes communication information indicating when and how communication has taken place among users.

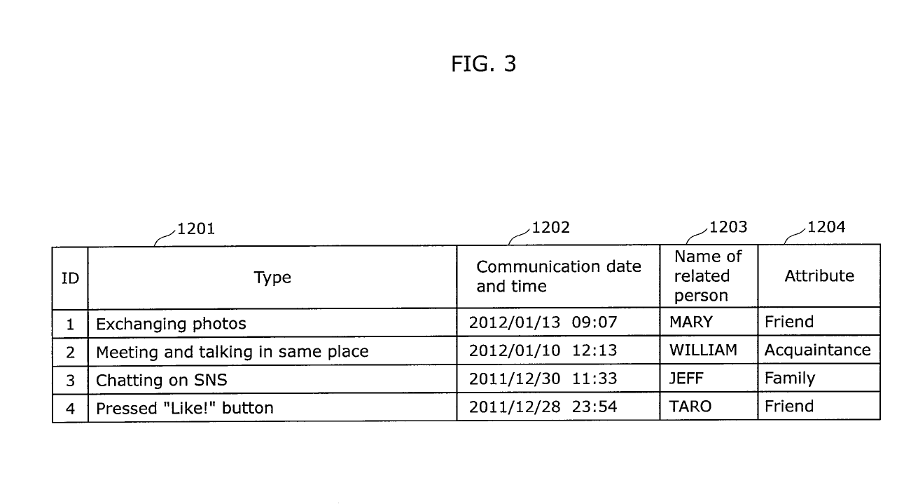

FIG. 3 is a table showing exemplary communication information. For purposes of illustration, the table shown in FIG. 3 shows exemplary communication information of one user. The relationship information storage unit 201 stores, for each user, the communication information shown in FIG. 3. In this embodiment, as shown in FIG. 3, the communication information includes communication history records (ID1 to ID4 in FIG. 3). Each of the communication history records includes: a type 1201 showing details of communication; a communication date and time 1202 showing a date and time of communication (a communication start date and time); a name of related person 1203 showing a name of a communication partner; and an attribute 1204 showing a relationship between a user and a communication partner (a related person or another user). In FIG. 3, the type 1201 shows: “Chatting on SNS” meaning a text conversation on a social networking service; “Exchanging photos” meaning an exchange of electronic data of photos; “Meeting and talking in same place” meaning a case where the same schedule (e.g., a rendezvous and watching sport) is registered; and “Pressed ‘Like!’ button” meaning an act of expressing empathy by pressing a button. It is to be noted that the type 1201 is not limited to this. The attribute 1204 shows a specific relationship between a user and a communication partner such as “Family,” “Friend,” and “Acquaintance” in this embodiment, and is information that the user has previously registered through a mobile terminal, a personal computer, or the like. The user selects, for each communication partner, one of pre-set attributes to perform attribute registration.

The relationship information transmitting unit 202 reads relationship information from the relationship information storage unit 201 and transmits the relationship information to the content presentation server 104, based on a request from the content presentation server 104.

The preference information management server 102 manages, for each user, check-in information and viewing history information as preference information, and includes: a check-in information storage unit 210 that stores check-in information; a viewing history information storage unit 211 that stores viewing history information; and a preference information transmitting unit 212 that transmits preference information to the content presentation server 104. In addition, the preference information management server 102 is connected to the content presentation terminal 105 owned by the user, through a network such as the Internet.

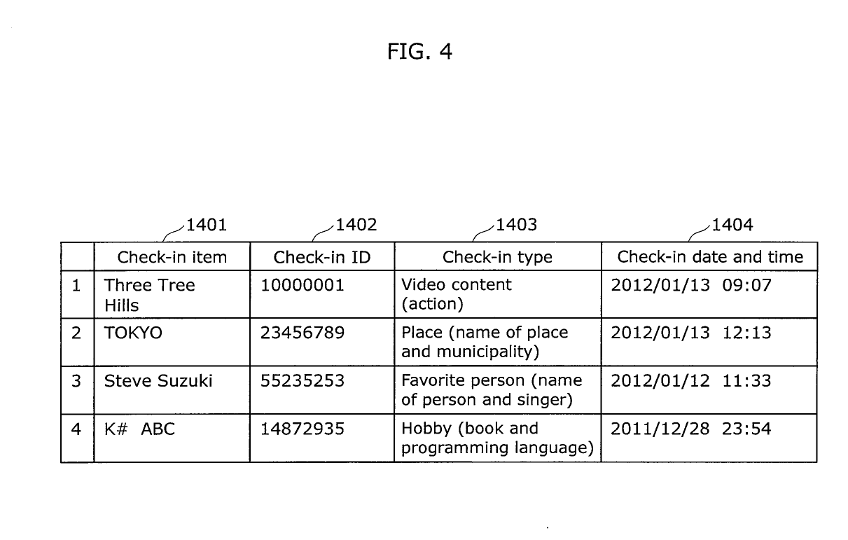

The check-in information storage unit 210 includes a database that stores, for each user, check-in information. FIG. 4 is a table showing exemplary check-in information.

The check-in information is information that a user actively selects (checks), through the mobile terminal, the personal computer, or the like, from a list of check-in items set according to categories such as video content, advertisement content, place, favorite person, hobby, and so on. In this embodiment, as shown in FIG. 4, the check-in information includes: a check-in item 1401 showing a check-in item; a check-in ID 1402 for uniquely identifying a check-in item; a check-in type 1403 showing a type of a check-in item; and a check-in date and time 1404 showing a date and time when a user actively performs checking. It is to be noted that in this embodiment, the check-in type 1403 includes names of the respective categories and names of respective subgenres obtained by further classifying each of the categories. When a category is for video content, examples of a genre include action, thriller, and variety.

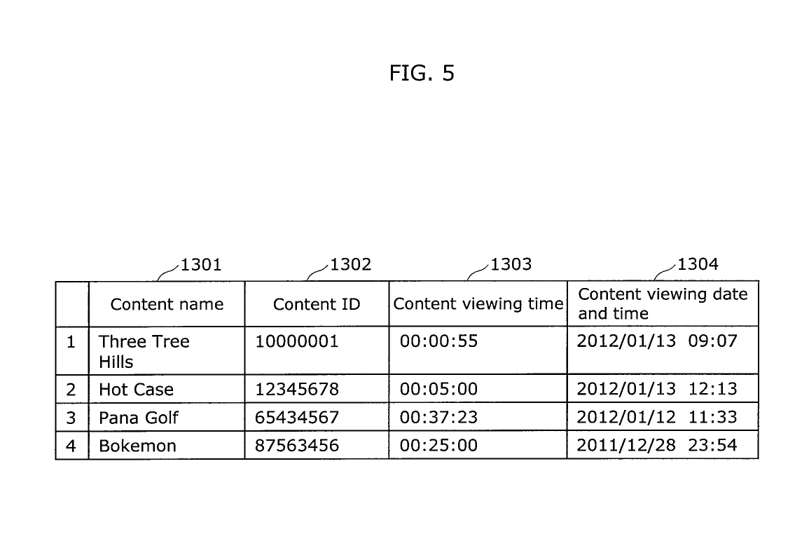

The viewing history information storage unit 211 is a database that collects, from the content presentation terminal 105 owned by the user, information about content items used (viewed) by the user and stores the information as viewing history information. FIG. 5 is a table showing exemplary viewing history information.

In this embodiment, as shown in FIG. 5, the viewing history information includes: a content name 1301 showing a name of a content item viewed by the user; a content ID 1302 for uniquely identifying a viewed content item; a content viewing time 1303 showing a time when the user viewed a content item; and a content viewing date and time 1304 showing a date and time when the user started viewing a content item.

The preference information transmitting unit 212 reads the check-in information and the viewing history information from the check-in information storage unit 210 and the viewing history information storage unit 211, respectively, and transmits the check-in information and the viewing history information to the content presentation server 104, based on a request from the content presentation server 104.

The content management server 103 manages metadata including: content identification information indicating content items associated with users (one or more content items having the same attribute as a content previously viewed in this embodiment); and information (a content genre) indicating an association between a preference and each of the content items. The content management server 103 includes: a content information storage unit 221 that stores the content identification information and the metadata; and a content information transmitting unit 222 that transmits the content identification information and the metadata.

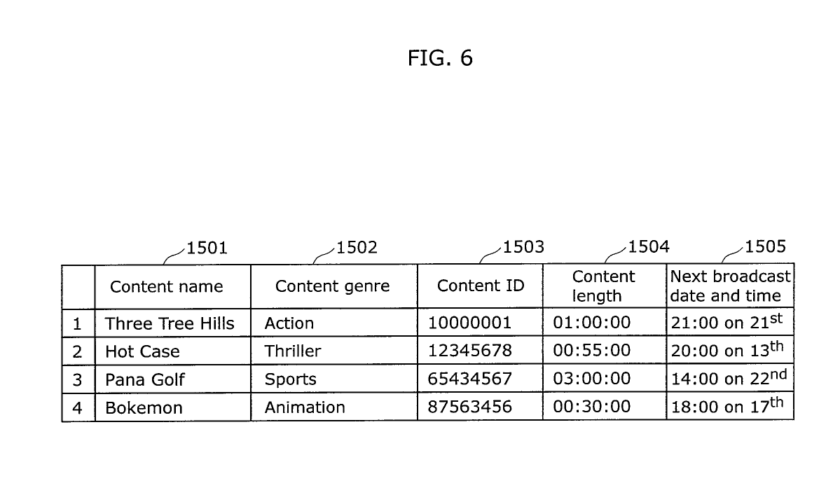

It is to be noted that, for purposes of illustration, this embodiment describes an example using video content items, especially TV content items related to TV broadcast, as content items. FIG. 6 is a table showing exemplary metadata of TV content items. In this embodiment, the metadata is information indicating relationships between preferences and content items. Here, the metadata is information including types (categories and genres) of content items. More specifically, as shown in FIG. 6, the metadata includes; a content name 1501; a content genre 1502 showing a type (genre) of a content item; a content ID 1503 for uniquely identifying a content item; a content length 1504 showing a reproduction time when a content item is a video content item; and a next broadcast date and time 1505. This embodiment describes an example using a case where the following 10 genres are set as content genres: “Action,” “Thriller,” “Sports,” “Animation,” “Variety,” “Comedy,” “Suspense,” “Drama,” “Horror,” and “Nature.”

The content information transmitting unit 222 reads the content identification information and the metadata from the content information storage unit 221, and transmits the content identification information and the metadata to the content presentation server 104, based on a request from the content presentation server 104.

The content presentation server 104 evaluates, for a content presentation target user who is a user to which content items are presented, each of content items associated with related persons of the content presentation target user, and outputs the evaluation results.

The content presentation server 104 includes: a relationship information receiving unit 231 (corresponding to part of an obtaining unit) that receives relationship information from the relationship information management server 101; a relationship information calculating unit 232 that calculates affinity score ranking indicating distances in affinity between a content presentation target user and related persons thereof, based on the received relationship information; a preference information receiving unit 233 (corresponding to part of the obtaining unit) that receives, from the preference information management server 102, preference information of the content presentation target user and preference information of the related persons; a content information receiving unit 235 (corresponding to part of the obtaining unit) that receives content identification information and metadata from the content management server 103; a preference information calculating unit 234 that calculates preference distance ranking indicating preference distances between the content presentation target user and the related persons, based on the received preference information items, content identification information, and metadata; a time information obtaining unit 236 that obtains a current time; a content evaluating unit 237 that evaluates presentability, priority order, or the like of content items based on the affinity score ranking, the preference distance ranking, and times when the respective content items are presented, and produces content evaluation results; and a presentation information transmitting unit 238 (corresponding to an output unit) that transmits the content evaluation results.

The content presentation terminal 105 is a terminal such as a television, a tablet, a smart phone, and a personal computer. This embodiment describes an example where the content presentation terminal 105 is the television. The content presentation terminal 105 includes: a presentation information receiving unit 251 that receives, from the content presentation server 104, the content evaluation results for the content presentation target user; and a content presenting unit 252 that causes a display panel (not shown) to present content items in a mode understandable for the content presentation target user.

In this embodiment, the content presenting unit 252 two-dimensionally presents the content items using an axis of relationship distances between the user and the related persons and an axis of preference distances between the user and the related persons. Such presentation allows the user to visually understand which content item is a content item that is highly likely to match the potential preference of the user, that is, which content item is a content item of a closely (intimately) related person which is dissimilar in preference.

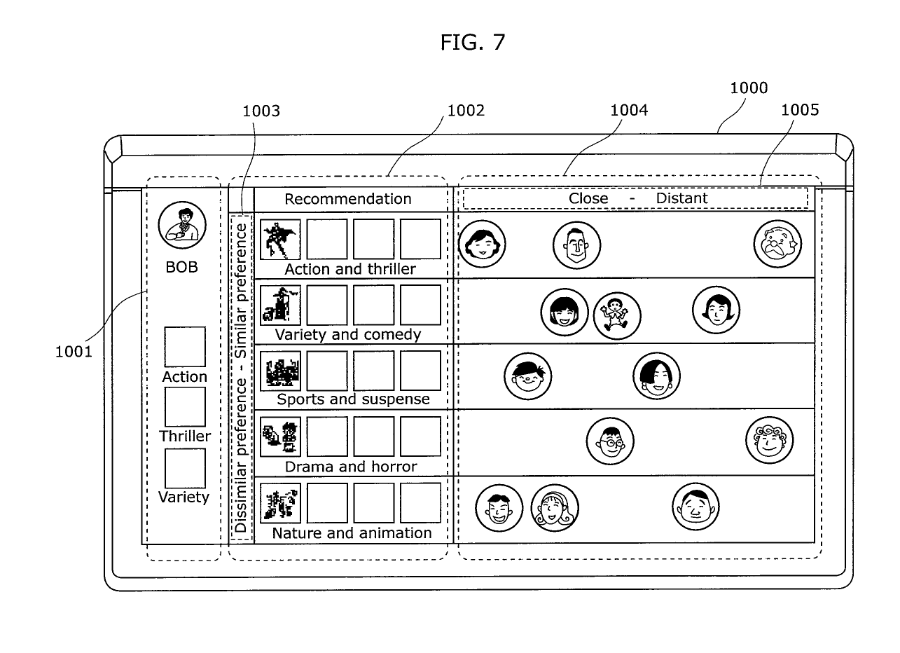

FIG. 7 is a diagram schematically showing a user interface 1000 presented by the content presenting unit 252.

The user interface 1000 is divided into three parts in a transverse direction, and includes: a region 1001 on the left side of the screen and for showing information about the content presentation target user; a presentation content display region 1002 at the center of the screen; and a mapping region 1004 on the right side of the screen.

The name of the content presentation target user is displayed in the upper part of the region 1001, and the top three genres of content items in which the content presentation target user is interested are displayed in the lower part of the region 1001. In the user interface 1000 shown in FIG. 7, the name of the content presentation target user is BOB.

An axis 1003 of preference distance (preference correlation) is placed at the left end of the presentation content display region 1002, and a part to the right of the axis 1003 is divided into five first divided regions in a longitudinal direction along the axis 1003. Two content genres are set in each of the first divided regions. A content item is presented in each first divided region based on the evaluation results of the content presentation server 104.

An axis 1005 of an affinity score is placed on the upper part of the mapping region 1004, and the lower part of the mapping region 1004 is divided into five second divided regions corresponding to the adjacent first divided regions. The related persons are mapped in the mapping region 1004 according to degrees of correlations (preference distances) between affinity scores and preferences.

(2. Operation)

Next, the following describes operation of the content presentation server 104 in the content presentation system 100 with reference to FIG. 7 to FIG. 12.

This embodiment describes a case where the user interface 1000 shown in FIG. 7 is displayed on the display screen of the content presentation terminal 105.

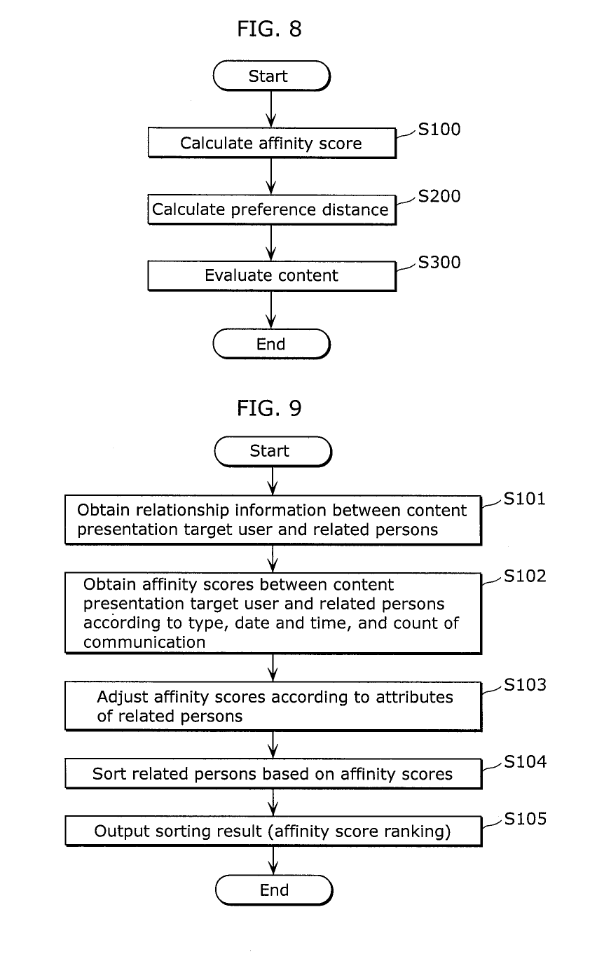

FIG. 8 is a flow chart showing the operation of the content presentation server 104.

Once processing begins, as shown in FIG. 8, the content presentation server 104 first causes the relationship information calculating unit 232 to calculate affinity score ranking in which the related persons are ranked in order of decreasing affinity score with the content presentation target user (Step S100).

FIG. 9 is a flow chart showing a method for calculating an affinity score in the relationship information calculating unit 232. As shown in FIG. 9, the relationship information calculating unit 232 first obtains relationship information that the relationship information receiving unit 231 received from the relationship information management server 101 (Step S101). Here, a case is described where the relationship information shown in FIG. 3 is obtained. It is to be noted that in this embodiment, information for a certain period of time such as information for a previous year is obtained as the relationship information, to reduce an amount of calculation performed by the relationship information calculating unit 232.

Next, the relationship information calculating unit 232 calculates, using the obtained relationship information, an affinity score between the content presentation target user and its related person according to a type of communication, a communication date and time, and the number of communications (Step S102). An affinity score N is calculated for each of related persons, and is expressed by the following Equation 1, where a coefficient set for each type of communication is k and an elapsed time from a communication start time is t.

N=Σk (10−log(t)) (Equation 1)

As shown in Equation 1, the affinity score N is calculated by multiplying, for each of communication history records, the coefficient k and a value obtained by subtracting, from 10, a logarithm of t whose base is 10, and summing the values of the communication history records which result from the multiplication. Here, Σ indicates a sum of the values of the respect communication history records. Moreover, the types of communication “Meeting and talking in same place,” “Exchanging photos,”“Chatting on SNS,” and “Pressed ‘Like!’ button” are assigned 15, 10, 6, and 3 as k, respectively, in this embodiment (see FIG. 3). The elapsed time t indicates a difference between a communicate date and time (start time) and a current time in a unit of second. The relationship information calculating unit 232 obtains the current time from the time information obtaining unit 236.

More specifically, when an affinity score N of a related person having the name “MARY” in FIG. 3 is calculated, ID1 is used. It is assumed that a current date and time is 2012/01/13, 10:20. In the case of ID1, when coefficient k of the communication type “Exchanging photos”=10 and elapsed time t=communication start time (2012/01/13, 09:07)−current date and time (2012/01/13, 10:20)=4380 are substituted in Equation 1, the affinity score N is calculated as 10×(10−log(4380))=approximately 63.6.

Next, the relationship information calculating unit 232 adjusts the affinity score N calculated in Step S102 by further multiplying the affinity score N by a certain scale factor according to an attribute of the related person of the content presentation target user (Step S103). The attributes “Family,” “Friend,” and “Acquaintance” have scale factors of 10, 3, and 1, respectively. The affinity score of the related person having the name “MARY” shown in FIG. 3 is adjusted to be 190.8.

The relationship information calculating unit 232 executes Step S101 to Step S103 in the same manner for the other related persons “WILLIAM,” “JEFF,” and “TARO,” to calculate affinity scores N between the content presentation target user and the related persons. The affinity scores N of “WILLIAM,” “JEFF,” and “TARO” are approximately 69.0, approximately 275.9, and approximately 41.4, respectively.

Next, the relationship information calculating unit 232 sorts the related persons based on the affinity scores N between the content presentation target user and the related persons calculated in Step S103, to generate affinity score ranking (Step S104). The affinity score ranking shows “JEFF,” “MARY,” “WILLIAM,” and “TARO” in this order from the top to the bottom.

The relationship information calculating unit 232 further outputs the affinity score ranking generated in Step S104 to the content evaluating unit 237 and the presentation information transmitting unit 238 (Step S105).

As above, the affinity score ranking of the related persons is generated for the content presentation target user.

After the generation of the affinity score ranking (Step S100), as shown in FIG. 8, the content presentation server 104 causes the preference information calculating unit 234 to calculate preference distance ranking in which the related persons are ranked in order of increasing preference distance (Step S200).

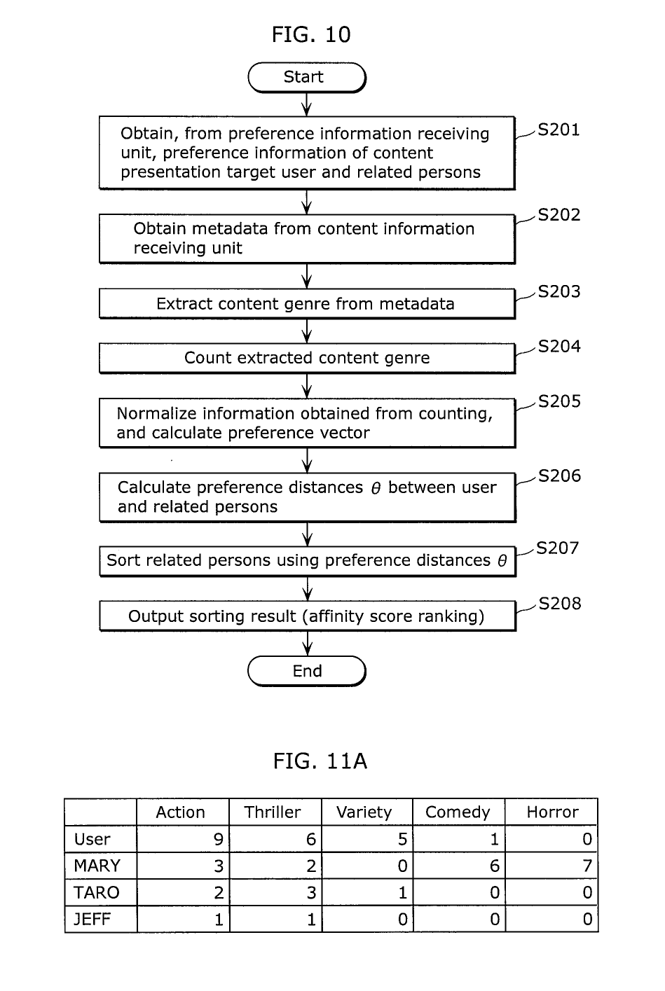

FIG. 10 is a flow chart showing a method for calculating preference distance ranking in the preference information calculating unit 234. As shown in FIG. 10, the preference information calculating unit 234 first obtains, from the preference information receiving unit 233, preference information of the content presentation target user and preference information of each of the related persons (Step S201).

The preference information calculating unit 234 further obtains, from the content information receiving unit 235, content identification information of the content presentation target user and content identification information of each related person, and metadata of content items indicated in the content identification information (Step S202). Here, the metadata shown in FIG. 6 is used as an example. It is to be noted that Step S201 may be executed after Step S202 is executed.

Next, the preference information calculating unit 234 extracts content genres 1502 from the metadata obtained in Step S202 (Step S203).

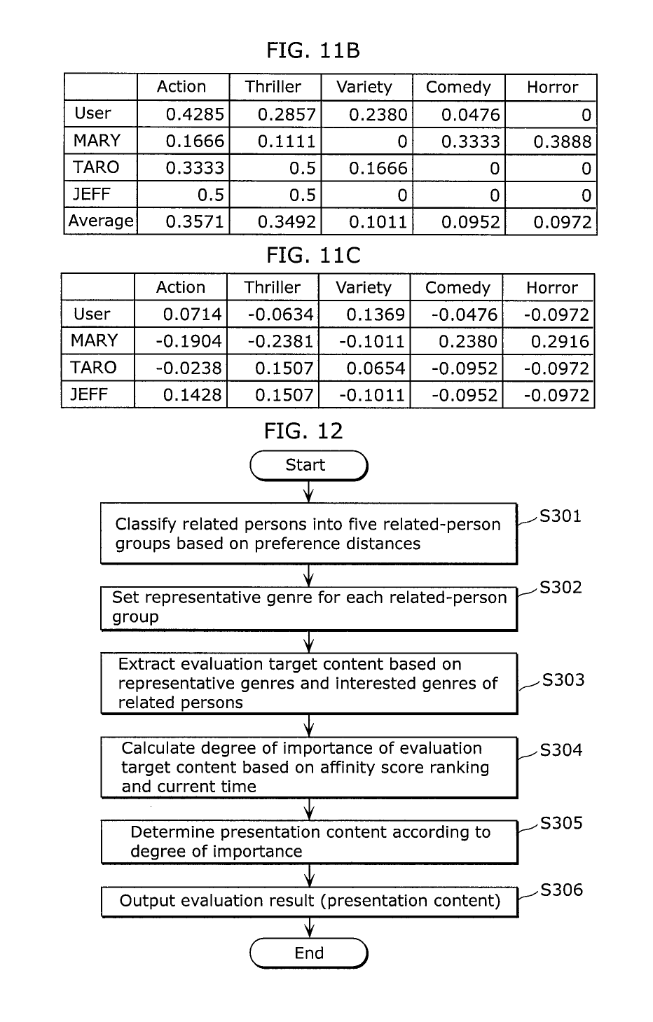

The preference information calculating unit 234 counts, for the content presentation target user and each related person, the number of content items associated with each of the content genres (Step S204). Here, FIG. 11A is a table showing exemplary counting results. For purposes of illustration, FIG. 11A shows the five content genres “Action,” “Thriller,” “Variety,” “Comedy,” and “Horror.” It is to be noted that the content genres shown in FIG. 11A do not completely correspond to the content genres shown in FIG. 7, because of the purposes of the illustration. FIG. 11A shows that the content presentation target user has more frequently used video content items in order of “Action,” “Thriller,” “Variety,” and “Comedy.” Likewise, as shown in FIG. 11A, the number of content items associated with each content genre is counted for each related person, that is, each of “MARY,” “TARO,” and “JEFF” in this embodiment.

Next, the preference information calculating unit 234 calculates, for the content presentation target user and each related user, a use ratio of content items by content genre, using the counting results obtained in Step S204, and calculates preference vectors by normalizing the use ratios (Step S205).

Here, FIG. 11B shows a table showing exemplary content use ratios by content genre. In this embodiment, a use ratio of content items in the content genre “Action” is a ratio of nine content items in the genre “Action” to a total number of used content items, that is, 21 (9+6+5+1). Thus, it is calculated as 9/21=0.4285. Likewise, use ratios of content items in other content genres and use ratios of content items by content genre are calculated for the content presentation target user and each related person, respectively.

FIG. 11C is a table obtained by normalizing the use ratios of content items by content genre for the respective users shown in FIG. 11B. The preference information calculating unit 234 calculates an average value of the use ratios by content genre, using the table shown in FIG. 11B. In this embodiment, the average value of the use ratios of content items in the content genre “Action” is 0.3571. The use ratios of content items in the content genre “Action” for the respective users are normalized by subtracting the average value from each of the use ratios, to cause a sum of the normalized use ratios to be 0. Likewise, the normalization is performed on the other content genres “Thriller,” “Variety,” “Comedy,” and “Horror.” In this embodiment, as shown in FIG. 11C, a value of the normalized use ratio of content items in the content genre “Action” for the content presentation target user is 0.4285−0.3571=0.0714. In the above manner, preference orientations of the content presentation target user and each related person, that is, preference vectors centering on each content genre are calculated.

Next, as shown in FIG. 10, the preference information calculating unit 234 calculates, from the preference vectors calculated in Step S205, a preference distance between the content presentation target user and each related person, using cosine similarity (Step S206).

Specifically, a preference distance θ is expressed by the following Equation 2, where a preference vector of the content presentation target user is v and a preference vector of a related person is w, the preference vectors centering on each content genre.

θ=v×w/(|V|*|w|) (Equation 2)

When the preference vector v of the content presentation target user is in the same orientation as the preference vector w of the related person, Equation 2 shows that the preference distance θ is 1, and when the preference vector v of the content presentation target user is in an orientation opposite to an orientation of the preference vector w of the related person, Equation 2 shows that the preference distance θ is −1. It is indicated that the closer the preference distance θ is to 1, the more similar preferences of the content presentation target user and the related person are. A preference distance θ between the content presentation target user and the related person “MARY” shown in FIG. 11C is −0.5284, and it is clear that the preference of the two is relatively dissimilar.

Next, the preference information calculating unit 234 sorts the related persons in order of increasing preference distance θ between the content presentation target user and each related person, to generate preference distance ranking (Step S207). It is to be noted that the sorting may be performed in order of decreasing preference distance θ.

Next, the preference information calculating unit 234 outputs the preference distance ranking to the content evaluating unit 237 (Step S208).

As above, the preference distance ranking of the related persons is generated for the content presentation target user.

After the calculation of the preference distance ranking (Step S200), as shown in FIG. 8, the content presentation server 104 causes the content evaluating unit 237 to calculate (evaluate) presentability or priority order of the content items associated with the related persons, based on the affinity score ranking and the preference distance ranking, and to output the presentability or the priority order as evaluation results to the content presentation terminal 105 (Step S300).

It is to be noted that this embodiment assumes, as stated above, the case where the content presenting unit 252 of the content presentation terminal 105 displays the user interface 1000 shown in FIG. 7.

FIG. 12 is a flow chart showing a method for evaluating a content item in the content evaluating unit 237.

As shown in FIG. 12, the content evaluating unit 237 first classifies, based on preference distance ranking, related persons into five related-person groups ranging from a related-person group in which a preference distance to a content presentation target user is closest to a related-person group in which a preference distance to the content presentation target user is farthest (Step S301). This is because the user interface 1000 shown in FIG. 7 presents content items in the five first divided regions corresponding to preference distances. It is to be noted that the number of the classified related-person groups is not limited to five, and may be the same as the number of the first divided regions of the user interface 1000. The number of the related-person groups is properly set according to a size of the display screen, the number of related persons, a total number of content genres, and so on.

Next, the content evaluating unit 237 sets a representative content genre (a representative genre) for each of the classified related-person groups (Step S302). In this embodiment, the number of content genres is 10, and the related persons are classified into the five related-person groups. Thus, the top two content genres among content genres preferred by a related person in each of the related-person groups are set as representative genres of each related-person group. However, the same content genre is prevented from being redundantly set as a representative genre of the related-person groups, and all content genres other than content genres set as representative genres of the four related-person groups are set for the related-person group in which the preference distance to the content presentation target user is farthest. With this, it is possible to present the content items in all the content genres. It is to be noted that the number of the representative genres set for each related-person group is not limited to two, and may be properly set according to the number of the related-person groups, the total number of the content genres, and so on. In addition, when the number of the content genres is very large, not every content genre may need to be set as a representative genre.

Next, the content evaluating unit 237 extracts, from the content items associated with the respective related persons, content items in the respective representative genres of the related-person groups to which the related persons belong to, as evaluation target content items (Step S303).

The content evaluating unit 237 further calculates a degree of importance for each of the extracted evaluation target content items, based on affinity score ranking and a relationship between a current time and a time of each extract evaluation target content item (Step S304).

In this embodiment, the content evaluating unit 237 calculates a degree of importance i using the following Equation 3.

i=r*u (Equation 3)

Here, a coefficient r is set according to a rank, in the affinity score ranking, of the related persons associated with the evaluation target content items extracted in Step S303. More specifically, the coefficient r is expressed by using a logarithm of the rank in the affinity score ranking. In the case of an n-th rank in the affinity score ranking, the coefficient r=10−log(n). In other words, in the cases of the first rank, the second rank, the third rank, and the fourth rank in the affinity score ranking, the coefficient r=10−log1=10, the coefficient r=10−log2≈10−0.3=9.7, the coefficient r=10−log3≈10−0.5=9.5, and the coefficient r=10−log4≈10−0.6=9.4, respectively. It is to be noted that a coefficient r is calculated for an evaluation target content item associated with related persons, using the highest rank of one of the related persons in the affinity score ranking.

A coefficient u indicates a relationship between a current time and a time of an evaluation target content item. The coefficient u is expressed by using a logarithm of a value representing a difference between the current time and the time of the evaluation target content item in a unit of second. When the difference between the current time and the time of the evaluation target content item is m second, the coefficient u=10−log(m). It is to be noted that the time of the evaluation target content item refers to a time at which the evaluation target content item is started, and is a “next broadcast date and time” in the metadata shown in FIG. 6 when the evaluation target content item is a TV content item.

The content evaluating unit 237 calculates the degree of importance i for each evaluation target content item. As is clear from Equation 3, the degree of importance i has a greater value as a rank in the affinity score ranking is higher and a period of time to the next broadcast date and time is shorter.

Next, the content evaluating unit 237 determines, from among the evaluation target content items extracted in Step S303, a presentation content item that is a content item to be presented to the content presentation target user, according to the degree of importance i of each of the evaluation target content items calculated in Step S304 (Step S305).

In this embodiment, a presentation content item is determined for each of the related-person groups. The content evaluating unit 237 selects, from among the evaluation target content items in the set representative genres, five or less evaluation target content items as five or less presentation content items in order of decreasing value of the degree of importance i, for each related-person group for which the presentation content is determined. With this, content items that are associated with a related person having a high rank in the affinity score ranking and have a short period of time to a next broadcast date and time are preferentially selected. It is to be noted that the number of the presentation content items in each content genre is determined according to a configuration of the user interface 1000 shown in FIG. 7. It is also to be noted that the number of the presentation content items does not always need to be determined by the largest number of content items displayable by the user interface 1000, and a presentation content item may be a content having a value of the degree of importance i greater or equal to a predetermined value, and so on.

The content evaluating unit 237 outputs, for each related-person group, the presentation content item determined in Step S305 in order of decreasing degree of importance i (in order of decreasing value) of content item (Step S306). Stated differently, in this embodiment, the content evaluating unit 237 outputs information identifying five content items to the related-person group in order of decreasing preference distance. It is to be noted that the output order may be another order, and information such as the degrees of importance i may be outputted.

As described, the execution of Step S100 to Step S300 makes it possible to determine the presentation content item suitable for each of the five related-person groups in terms of the content genres ranging from the genre similar to the preference of the content presentation target user to the genre dissimilar to the preference of the content presentation target user.

(3. Method for Presenting Content Item)

The following describes operation of the content presentation terminal 105 in the content presentation system 100 in this embodiment with reference to FIG. 7.

In the content presentation terminal 105, the content presenting unit 252 displays the user interface 1000 shown in FIG. 7 on the display screen, based on the evaluation results received by the presentation information receiving unit 251.

The content presenting unit 252 displays content items in the presentation content display region 1002 based on the evaluation results. In this embodiment, the content presenting unit 252 first assigns the related-person groups to the first divided regions from the top in order of decreasing affinity score with the content presentation target user, and displays a representative genre name of each of the related-person groups. In addition, the five content items are assigned to each of the first divided regions from the top in the order the content items are outputted from the content evaluating unit 237, and are displayed in each first divided region.

Moreover, the content presenting unit 252 displays images indicating the related persons in the second divided regions of the corresponding related-person groups in the mapping region 1004, based on the affinity score ranking calculated by the relationship information calculating unit 232. Such display of the related persons allows the content presentation target user to easily understand the affinity scores with the related persons. In addition, the presentation content display region 1002 and the related person mapping region 1004 share the axis 1003 representing the preference distance, which allows the content presentation target user to know a presentation content item and a related person associated with the presentation content item, and to visually understand why the content item is presented.

### Embodiment 2

The following describes a content presentation system according to Embodiment 2 with reference to the drawings.

The content presentation system according to this embodiment differs from the content presentation system according to Embodiment 1 in presenting not a viewing content item but an event content item.

Here, the event content item is a content item for announcing the holding of an event, reserving or selling a ticket, and so on. This embodiment describes an example where the event is a concert, a concert for children, a sports game (watching), a food tasting (drink tasting) event, illuminations, and so on.

(1. Structure)

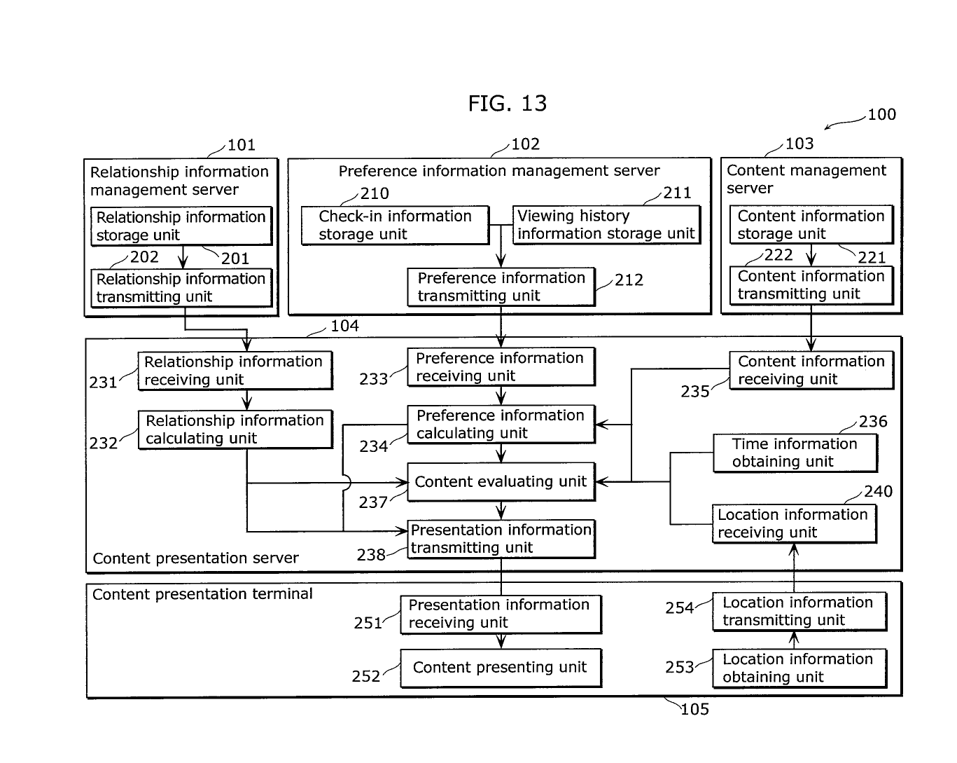

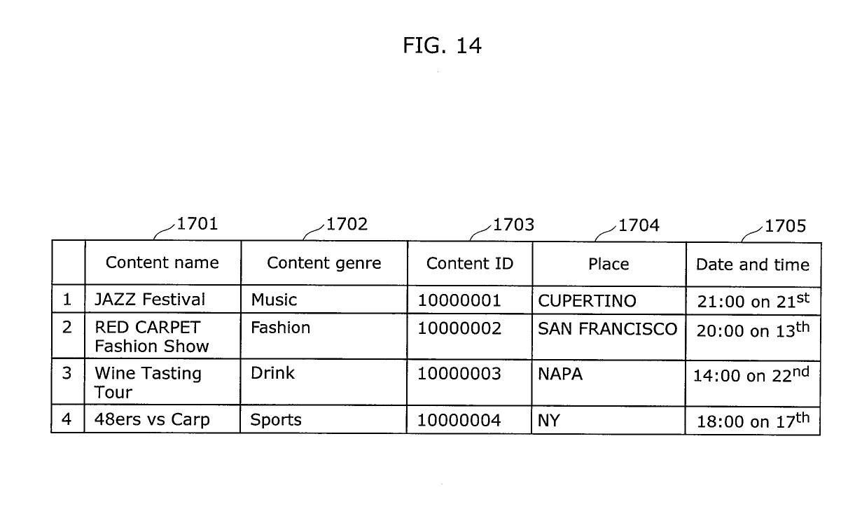

First, the following describes a structure of a content presentation system according to this embodiment with reference to FIG. 13 to FIG. 14.

FIG. 13 is a block diagram showing a configuration of each of servers included in a content presentation system 100 in this embodiment. In FIG. 13, the same numerical references are assigned to the same structural elements as those in the structure of Embodiment 1 shown in FIG. 2.

As shown in FIG. 13, the content presentation system 100 includes: a relationship information management server 101 that manages, for each user, relationship information between the user (a first user) and each of related persons (second users); a preference information management server 102 that manages, for each user, preference information; a content management server 103 that manages content items; a content presentation server 104 that evaluates, based on relationship information and preference information, content items to be presented to a content presentation target user to which the content items are presented; and a content presentation terminal 105 that presents the content items to the content presentation target user. It is to be noted that the relationship information management server 101 and the preference information management server 102 have the same configurations as in Embodiment 1.

In this embodiment, the content management server 103 (i) manages content identification information indicating content items (event content items in this embodiment) associated with respective users, and metadata including information indicating a relationship between a preference and each of the content items, and (ii) includes a content information storage unit 221 that stores the metadata, and a content information transmitting unit 222 that transmits the content identification information and the metadata to the content presentation server 104.

FIG. 14 is a table showing exemplary metadata of event content items. In this embodiment, as shown in FIG. 14, the metadata includes: a content name 1701; a content genre 1702 showing a type (genre) of a content item; a content ID 1703 for uniquely identifying a content item; a place 1704 showing a place where an event indicated by a content item takes place; and a date and time 1705 showing a date and time of the holding of an event indicated by a content item. This embodiment describes an example using a case where the following genres are set as content genres: “Music,”“Fashion,”“Wine,”“Sports (football),” “Kids,” “Illuminations,” and so on.

In this embodiment, the content presentation server 104 includes a relationship information receiving unit 231, a relationship information calculating unit 232, a preference information receiving unit 233, a content information receiving unit 235, a preference information calculating unit 234, a time information obtaining unit 236, a content evaluating unit 237, a presentation information transmitting unit 238, a location information receiving unit 240 that receives location information from the content presentation terminal 105. It is to be noted that although the relationship information receiving unit 231, the relationship information calculating unit 232, the preference information receiving unit 233, the content information receiving unit 235, the preference information calculating unit 234, the time information obtaining unit 236, and the presentation information transmitting unit 238 handle different content items from those in Embodiment 1, all of these have the same configurations as in Embodiment 1.

In this embodiment, the content evaluating unit 237 evaluates presentability, priority order, or the like of content items based on places where respective events take place, in addition to affinity score ranking, preference distance ranking, and a current time, and produces content evaluation results.

As with Embodiment 1, the content presentation terminal 105 is a terminal such as a television, a tablet, a smart phone, and a personal computer. This embodiment describes an example where the content presentation terminal 105 is the television. The content presentation terminal 105 includes: a presentation information receiving unit 251 that receives, from the content presentation server 104, the content evaluation results for the content presentation target user; a content presenting unit 252 that presents content items in a mode understandable for the content presentation target user; a location information obtaining unit 253 that obtains location information of the content presentation terminal 105; a location information transmitting unit 254 that transmits the location information obtained by the location information obtaining unit 253 to the content presentation server 104 through a communication network such as the Internet. It is to be noted that the presentation information receiving unit 251 has the same configuration as in Embodiment 1.

In this embodiment, the content presenting unit 252 displays, on a display screen, content items in genres preferred by the content presentation target user and content items in genres never used by the content presentation target user.

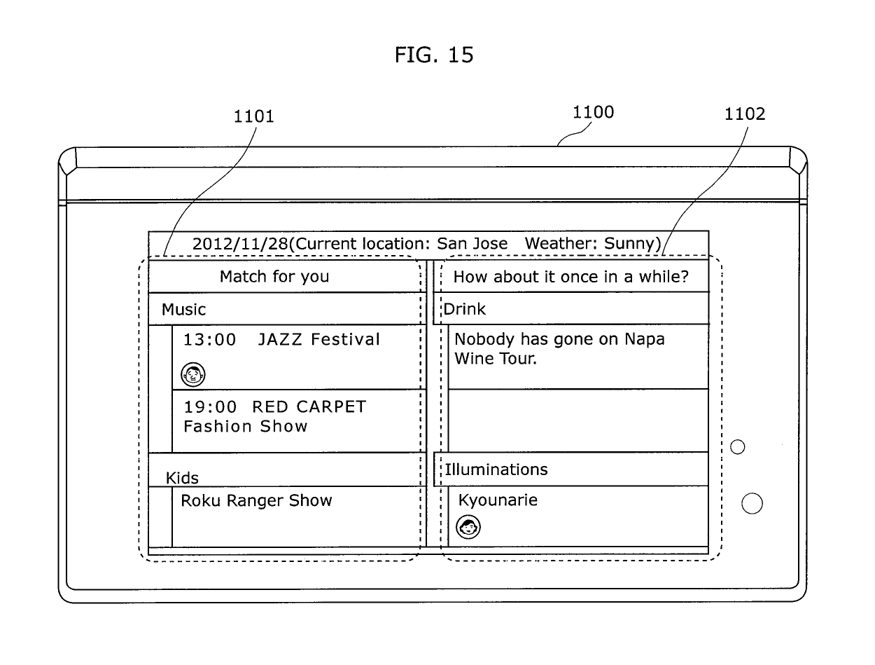

FIG. 15 is a diagram schematically showing a user interface 1100 presented by the content presenting unit 252.

The user interface 1100 is divided into two parts in a traverse direction, and includes: a first presentation content display region 1101 on the left side of the screen; and a second presentation content display region 1102 on the right side of the screen.

Genre names of genres of interest to the content presentation target user and content items classified into the genres are displayed in the first presentation content display region 1101. Genre names of genres of content items previously never used by the content presentation target user (genres deemed of no interest to the content presentation target user) and of interest to related persons, and content items classified into the genres are displayed in the second presentation content display region 1102.

(2. Operation)

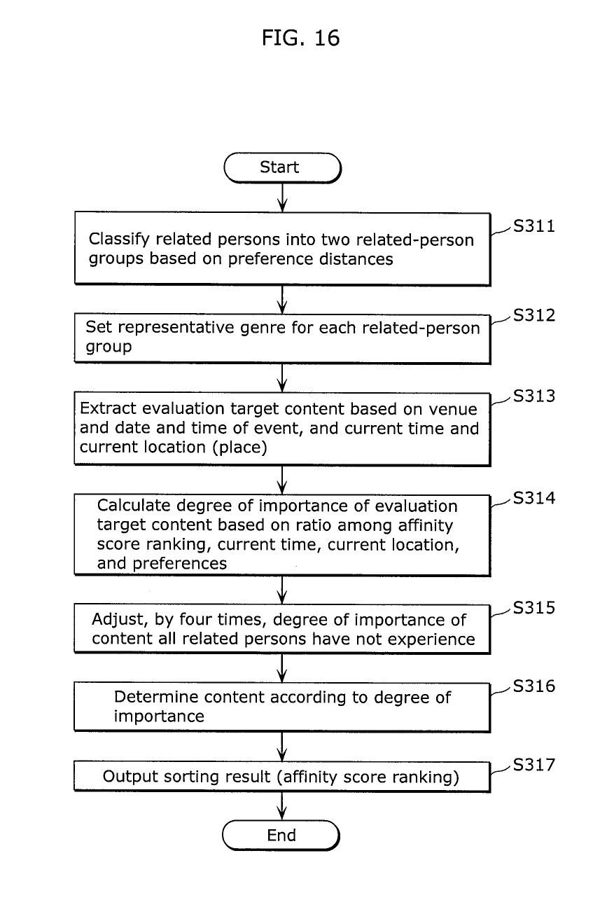

The following describes operation of the content presentation server 104 in the content presentation system 100 in this embodiment with reference to FIG. 8 and FIG. 16. It is to be noted that description of the same operation as in Embodiment 1 is omitted appropriately.

This embodiment describes a case where the user interface 1100 shown in FIG. 15 is displayed on the display screen of the content presentation terminal 105.

Once processing begins, as shown in FIG. 8, the content presentation server 104 first causes the relationship information calculating unit 232 to calculate affinity score ranking in which related persons are ranked in order of decreasing affinity score to the content presentation target user (Step S100). It is to be noted that a method for calculating affinity score ranking is the same as in Embodiment 1.

Next, the content presentation server 104 causes the preference information calculating unit 234 to calculate preference distance ranking in which the related persons are ranked in order of increasing preference distance to the content presentation target user (Step S200). It is to be noted that although a method for calculating preference distance ranking differs depending on whether a content item to be handled is a viewing content item or an event content item, the method for calculating preference distance ranking is the same as in Embodiment 1.

The content presentation server 104 continuously causes the content evaluating unit 237 to calculate (evaluate) presentability or priority order of content items associated with the related persons, based on the affinity score ranking and the preference distance ranking, and to output the presentability or the priority order as evaluation results to the content presentation terminal 105 (Step S300).

FIG. 16 is a flow chart showing a method for evaluating a content item in the content evaluating unit 237.

As shown in FIG. 16, the content evaluating unit 237 first classified the related persons into two related-person groups that are a related-person group in which a preference distance to the content presentation target user is close and a related-person group in which a preference distance to the content presentation target user is far, based on the preference distance ranking (Step S311). This is because the user interface 1100 shown in FIG. 15 presents content items in the two regions (the first content presentation region 1101 and the second content presentation region 1102). It is to be noted that the number of the classified related-person groups is not limited to two.

Next, the content evaluating unit 237 sets a representative genre for each of the classified related-person groups (Step S312). In this embodiment, the top four genres among content genres preferred by a related person in the related-person group in which the preference distance is close are set as representative genres of the related-person group. All content genres other than the four genres set as the representative genres of the related-person group in which the preference distance is close are set as representative genres of the related-person group in which the preference distance is far. It is to be noted that the number of the representative genres set for each related-person group is not limited to this, and may be properly set according to the number of the related-person groups, a total number of the content genres, and so on. In addition, not every content genre may need to be set as a representative genre.

Next, in this embodiment, the content evaluating unit 237 extracts, as evaluation target content items, content items that the content presentation target user can participate in, based on the content identification information obtained by the content information receiving unit 235, a location (a current location) indicated in the location information obtained from the location information receiving unit 240, and a time (a current time) indicated in time information obtained from the time information obtaining unit 236 (Step S313).

More specifically, the content evaluating unit 237 first extracts event content items identified by content identification information. Moreover, the content evaluating unit 237 obtains, for each of the extracted event content items, a place 1704 (a venue) where an event indicated by each event content item takes place, from the metadata shown in FIG. 14, and extracts event content items whose venues are within a certain radius from the current location. Here, the content evaluating unit 237 extracts event content items whose venues are within a 100-km radius from the current location. Furthermore, the content evaluating unit 237 obtains dates and times 1705 (event dates and times) when events indicted by the extracted event content items, from the metadata shown in FIG. 14, and extracts, as evaluation target content items, event content items whose event dates and times are within seven days from the current time, from the extracted event content items. It is to be noted that an event content item whose event date and time is a certain number of hours passed from the current time may be not extracted as an evaluation target content item.

Moreover, the content evaluating unit 237 calculates, for each extracted evaluation target content item, a degree of importance based on the affinity score ranking, a relationship between the current time and the event time, a relationship between the current location and the event location, and preferences of the content presentation target user (Step S314).

In this embodiment, the content evaluating unit 237 calculates a degree of importance i using the following Equation 4.

i=r*u*d*s (Equation 4)

Here, as with Embodiment 1, a coefficient r is set according to a rank in the affinity score ranking of the related persons associated with the evaluation target content items extracted in Step S313. In the case of an n-th rank in the affinity score ranking, the coefficient r=10−log(n).

As with Embodiment 1, a coefficient u indicates a relationship between a current time and a time of an evaluation target content item, and a relationship between a time indicated in current time information and an event date and time of an event indicated by an event content item. The coefficient u is expressed by using a logarithm of a value representing a difference between the current time and the event date and time of the evaluation target content item in a unit of second. When the difference between the current time and the event date and time of the evaluation target content item is m second, the coefficient u=10−log(m).

A coefficient d indicates a relationship between a current location and a location of an event indicated by an event content item. The coefficient d is expressed by using a logarithm of a distance between the event location (the place 1704 in FIG. 14) and the current location. When the difference between the event location and the current location is I, the coefficient d=10−log(I).

A coefficient s is a ratio of a preference of the content presentation target user, is expressed as a ratio of a content genre to which a content item for which a degree of importance i is calculated belongs, and is calculated by the same method as in Step S201 to Step S205 of Embodiment 1 shown in FIG. 10 (see FIG. 11A to FIG. 11C).

The content evaluating unit 237 calculates the degree of importance i for each of all the evaluation target content items.

Next, the content evaluating unit 237 multiplies, by four, a degree of importance i of a content item not preferred by the content presentation target user and all the related persons (not experienced (used) by all the related persons) among the evaluation target content items extracted in Step S313 (Step S315). It is to be noted that although an event content item is presented for promoting the use of event as one of purposes, it is considered that there is a possibility that the content presentation target user has already recognized, through word of mouth or the like, a content item already experienced by the related persons. In contrast, there is a high possibility that the content item not experienced by the content presentation target user and all the related persons is not recognized by the content presentation target user. By increasing the degree of importance of such a content item to make the content item easy to be selected as a presentation content item, it is possible to more accurately present the content item unexpected to the content presentation target user and corresponding to a potential preference of the content presentation target user.

The content evaluating unit 237 determines, from among the evaluation target content items extracted in Step S303, a presentation content item according to the degree of importance i obtained up to Step S315 (Step S316).

As with Embodiment 1, a presentation content item is determined for each of the related-person groups. In this embodiment, the content evaluating unit 237 sorts the evaluation target content items based on the representative genres set for the two related-person groups set in Step S312. The content evaluating unit 237 selects, from among the evaluation target content items in the set representative genres, two or less evaluation target content items as two or less presentation content items in order of decreasing value of the degree of importance i, for each related-person group. It is to be noted that the number of the presentation content items in each content genre is determined according to a configuration of the user interface 1100 shown in FIG. 15.

The content evaluating unit 237 outputs, for each related-person group, the sorted presentation content items in order of decreasing degree of importance i (in order of decreasing value) of content item (Step S317).

As described above, it is possible to provide the presentation content items suitable for each of the content genre similar to the preference of the content presentation target user and the content genre dissimilar to the preference of the content presentation target user. With this, the content presentation target user can obtain both the content items similar to the preference of the content presentation target user and the content items unexpected to the content presentation target user.

(3. Method for Presenting Content Item)

The following describes operation of the content presentation terminal 105 in the content presentation system 100 in this embodiment with reference to FIG. 15.

In the content presentation terminal 105, the content presenting unit 252 displays the user interface 1100 shown in FIG. 15 on a display screen, based on the evaluation results received by the presentation information receiving unit 251.

The content presenting unit 252 displays, in the first presentation content display region 1101, two representative genres of the related-person groups in each of which the preference distance to the content presentation target user is close, and the two or less presentation content items determined for each representative genre in Step S316. It is to be noted that although only the two representative genres are shown in FIG. 15, FIG. 15 shows only the part of the content presentation screen, and scroll operation or the like makes it possible to display presentation content items not shown in FIG. 15. The content presenting unit 252 also displays, in the second presentation content display region 1102, two representative genres in each of which the preference distance to the content presentation target user is far, and the presentation content item determined for each representative genre in Step S316. It is to be noted that although the representative genre in which the preference distance to the content presentation target user is far is a content genre judged to be of no interest to the content presentation target user, such a representative genre is a content genre judged to be of interest to a related person. The user interface 1100 shown in FIG. 15 further displays the related persons associated with the respective presentation content items (who is interested in a corresponding one of the presentation content items) or none of the content presentation target user and the related persons having used the presentation content items (places where none of them has been to). With this configuration, it is possible to know the presentation content items and the related persons associated with the presentation content items, and visually understand why the presentation content items are presented.

### Other Embodiments

(1) Although, in Embodiments 1 and 2, the calculation of a preference distance (a preference vector) for each content genre (Step S200) and the determination of an evaluation target content item (Step S302 and Step S303) based on the evaluation of a content item (Step S300) are performed using the content genres each as the information indicating the relationship between the content item and the preference, the present disclosure is not limited to those.

For instance, in Embodiment 1, other information such as a production company, a character, and a keyword may be used as the information indicating the relationship with the preference, or the other information and one or more content genres may be combined as the information indicating the relationship with the preference (a classification condition).

In this case, the preference information calculating unit 234 extracts information according to a classification condition, from the metadata stored in the content information storage unit 221 and obtained through the content information receiving unit 235 (Step S203). In addition, the preference information calculating unit 234 classifies content items based on classification conditions (attributes), and calculates preference vectors (Step S204 to Step S206).

Moreover, the content evaluating unit 237 sets, for each related-person group, a representative classification condition instead of the representative genre (Step S302), and determines viewing history records matching the representative classification conditions as evaluation target content items (Step S303).

In Embodiment 2, other information such as a host, a performer, and a keyword may be used as the information indicating the relationship with the preference, or the other information and one or more content genres may be combined as the information indicating the relationship with the preference (a classification condition).

In this case, as stated above, the preference information calculating unit 234 extracts information according to a classification condition, from the metadata stored in the content information storage unit 221 and obtained through the content information receiving unit 235 (Step S203). In addition, the preference information calculating unit 234 classifies content items based on classification conditions (attributes), and calculates preference vectors (Step S204 to Step S206).

Moreover, in Embodiment 2, the content evaluating unit 237 sets, for each related-person group, a representative classification condition instead of the representative genre (Step S312), and determines event content items matching the representative classification conditions as evaluation target content items (Step S303).

(2) Although the use ratios of the content items for the respective content genres are calculated and the preference vectors are calculated by normalizing the use ratios in Embodiments 1 and 2, the use ratios of the content items may be adjusted using check-in information, and preference vectors may be calculated by normalizing the adjusted use ratios of the content items. For example, it is considered that the number of checks in check-in information associated with content genres is counted for each content genre, and the use ratios of the content items may be adjusted according to the number of the checks.

The case where the user registers in advance the check-in information has been described as the example, the present disclosure is not limited to this. For instance, check-in information may be extracted from a text message posted on a social networking service by the user. More specifically, proper nouns may be extracted by morphological analysis from the text posted on the social networking service, a frequent keyword may be determined from among the proper nouns and estimated as a proper noun of interest to the user, and the estimated proper noun may be automatically stored in the check-in information storage unit 210.

It is to be noted that as described in the other embodiment (1), when the preference vector is calculated for each classification condition, use ratios of content items calculated for the respective classification conditions may be normalized, and then the use ratios may be adjusted using the check-in information.

(3) Although the viewing history information of television broadcast is used as the preference information of the user or each of the related persons, the present disclosure is not limited to this, and a reservation history, a recording history, a purchase history, a reading history, a Web browsing history, and so on may be used.

(4) Although the content evaluating unit 237 sets the representative genre for each related-person group (Step S302) and selects the content items to be presented from the representative genre (Step S303) in Embodiment 1, content items to be presented may be selected without determining representative genres.

In this case, the content evaluating unit 237 determines, for each related-person group, viewing content items of all related persons in the related-person group as evaluation target content items.

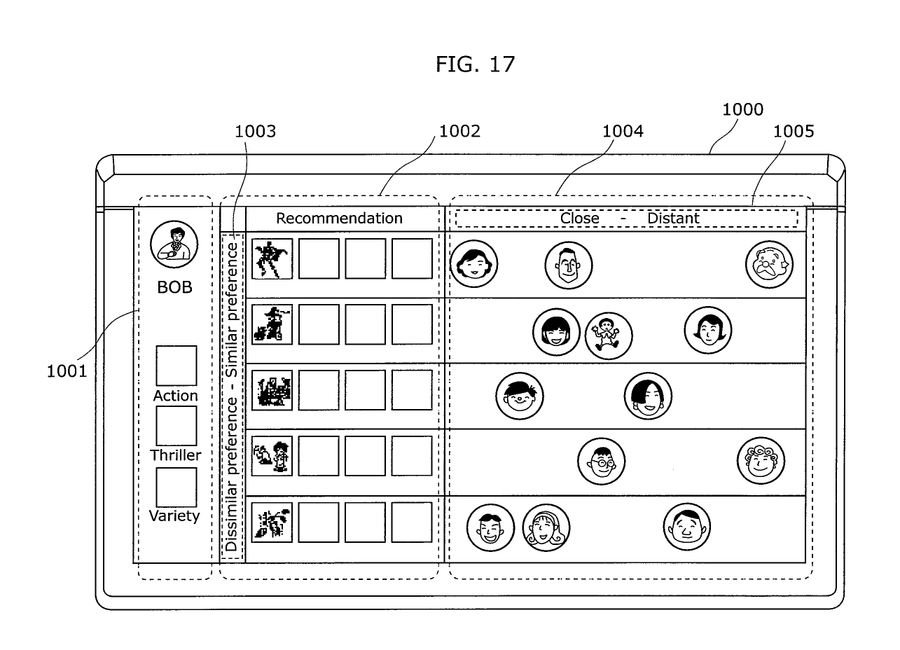

Here, FIG. 17 is a diagram schematically showing the user interface 1000 presented by the content presenting unit 252 of the content presentation terminal 105 when the content evaluating unit 237 selects content items without determining representative genres.

In this case, for instance, when content items having the same value of degrees of importance i are present, priority order may be set for each content genre or each classification condition.

When the presentation content items are selected without determining the representative genres, content items other than representative content items can be also presented. There is a high possibility that a content item related to a potential preference of the user is included in content items viewed by a related person having a high affinity score and a far preference distance. Thus, it is also considered desirable to perform the presentation regardless of genres (or classification condition). By selecting the content items to be presented without determining the representative genres, it is possible to more flexibly present the content items of the related person having the high affinity score and the far preference distance in order of decreasing viewing history record.

It is to be noted that in Embodiment 1, setting all the genres (or the classification conditions) as the representative genres of one of the related-person groups reduces a possibility that a genre (or a classification condition) in which no content item is presented occurs, and makes it possible to present the content items in all the genres. As a result, it is possible to present content items from a broader genre (or classification condition).

Likewise, although the content evaluating unit 237 sets the representative genre for each related-person group (Step S312) and selects the content items to be presented from the representative genre (Step S313) in Embodiment 2, content items to be presented may be selected without determining representative genres.

(5) Although the method for ranking using the affinity score N and the preference distance θ is employed in the calculation of affinity score ranking in Embodiments 1 and 2, related persons may be grouped on a content genre basis using a dimension reduction method or clustering using degree centrality, and then the groups may be ranked.

(6) The content genre and the representative genre each may be developed into layers such as a main genre and a subgenre. In this case, representative genres assigned to related-person groups may be on a main genre basis or a subgenre basis.

(7) Although place name information is used as place information, latitude and longitude information may be directly used.

(8) In Embodiment 2, the location information obtaining unit 253 of the content presentation terminal 105 may be a physical means such as a GPS and Wi-Fi (registered trademark) or may obtain posted information to which a related person tagged the user on a social networking service or location information of the user determined from schedule information of the user.

(9) A relationship other than a time or a place may be used as a calculation condition for a degree of importance i or content extraction condition in Embodiments 1 and 2. For example, weather information may be obtained using time information and place information respectively obtained from the time information obtaining unit 236 and the location information obtaining unit 253, and an event content item of an outdoor event having a high possibility that it would rain on an event date and time is excluded from evaluation target content items, or a degree of importance i is set to decrease a degree of importance of such an event content item.

(10) In DESCRIPTION, steps describing a program recorded on a recording medium include processes not necessarily chronologically executed but executed in parallel or individually, let alone processes chronologically executed in described order.

(11) It is to be noted that in Embodiments 1 and 2, each of the functional blocks in the block diagrams (FIG. 2 and FIG. 13) is typically achieved as an LSI that is an integrated circuit. These LSIs may be integrated into individual chips, or into a single chip so as to include part or all of the LSIs. Although an integrated circuit is referred to as an LSI here, it may also be referred to as an IC, a system LSI, a super LSI, or an ultra LSI depending on a difference in a degree of integration.

Moreover, a circuit integration method is not limited to the LSI, and may be achieved with a dedicated circuit or a general-purpose processor. FPGA (Field Programmable Gate Array) permitting programming after the manufacture of the LSI or a reconfigurable processor which can reconfigure connection or setting of circuit cells in the LSI may be used.

Additionally, if a new circuit integration technique is introduced in place of the LSI along with development in semiconductor technology or other derivative technology, it is obvious that the technique may be used for integrating functional blocks. There is a possibility of applying biotechnology and the like.

Furthermore, in Embodiments 1 and 2, each of the structural elements may be configured by dedicated hardware, or one or more of the structural elements that can be achieved by software may be achieved by executing a program.

Although only some exemplary embodiments of the present invention have been described in detail above, those skilled in the art will readily appreciate that many modifications are possible in the exemplary embodiments without materially departing from the novel teachings and advantages of the present invention. Accordingly, all such modifications are intended to be included within the scope of the present invention.

### INDUSTRIAL APPLICABILITY

The present disclosure makes it possible to more accurately present to a user a content item related to a potential preference of the user such as an unexpected content item, and thus is useful as a server system providing web services, a person computer and a table terminal or a mobile terminal that are capable of displaying and selecting content items.

1. A content presentation device comprising:
an obtaining unit configured to obtain first preference information indicating a preference of a first user, second preference information indicating a preference of a second user, content identification information identifying a plurality of content items associated with the second user, and relationship information indicating a relationship between the first user and the second user;
a content evaluating unit configured to evaluate display of each of the content items identified by the content identification information, based on the relationship information and a preference correlation between the preference indicated by the first preference information and the preference indicated by the second preference information; and
an output unit configured to output evaluation information indicating a result of the evaluation performed by the content evaluating unit,
wherein the content evaluating unit is configured to give a high evaluation to at least one of the content items associated with the second user, the at least one content item having the preference correlation lower than a certain preference correlation and an affinity score higher than a certain affinity score, and the affinity score indicating strength of the relationship between the first user and the second user indicated by the relationship information.

2. The content presentation device according to claim 1,
wherein the content evaluating unit is configured to perform the evaluation using, as a display target, a content item whose affinity score is high and preference correlation is low, among the content items.

3. The content presentation device according to claim 1,
wherein the content evaluating unit is configured to perform the evaluation by increasing a priority level of display of a content item whose affinity score is high and preference correlation is low, among the content items.

4. The content presentation device according to claim 1,
wherein the obtaining unit is configured to obtain, as the second preference information, second history information indicating a content item used by the second user, and
the content evaluating unit is configured to perform the evaluation using, as a display target, a content item not stored as the second history information.

5. The content presentation device according to claim 1,
wherein the obtaining unit is configured to obtain, as the second preference information, second history information indicating a content item used by the second user, and
the content evaluating unit is configured to perform the evaluation by increasing a priority level of display of a content item not stored in the second history information.

6. The content presentation device according to claim 1,
wherein the obtaining unit is further configured to obtain location information of the at least one content item, and
the content evaluating unit is configured to perform, using, as an evaluation target content item, a content item among the content items identified by the content identification information, the evaluation on the evaluation target content item, the content item having a distance between a current location of the first user and a location indicated by the location information of the at least one content item less than a predetermined distance.

7. The content presentation device according to claim 1,
wherein the obtaining unit is further configured to obtain time information of the at least one content item, and
the content evaluating unit is configured to perform, using, as an evaluation target content item, a content item among the content items identified by the content identification information, the evaluation on the evaluation target content item, the content item having a difference between a current time and the time information of the at least one content item less than a predetermined value.

8. The content presentation device according to claim 1,
wherein the content evaluating unit is configured to classify a plurality of the second users into related-person groups based on strength of a plurality of the preference correlations, determine, for each of the relation-person groups, part of the content items identified by the content identification information, as evaluation target content items, based on a plurality of the second preference information items, and perform the evaluation on the evaluation target content items.

9. The content presentation device according to claim 1,
wherein the content evaluating unit is configured to calculate the preference correlation using cosine similarity.

10. The content presentation device according to claim 1,
wherein each of the first preference information and the second preference information is information indicating a preference for each of genres,
the obtaining unit is further configured to obtain the genres of the respective content items, and
the content evaluating unit is configured to perform the evaluation, based on the genres of the respective content items in addition to the preference correlation.

11. A content presentation terminal comprising:
a receiving unit configured to receive the evaluation information from the output unit of the content presentation device according to claim 1; and
a display unit configured to display the at least one content item along a preference axis indicating strength of the preference correlation with the first user, based on the evaluation information, and place display of the second user in a display region defined by the preference axis and an affinity axis indicating the affinity score with the first user.

12. A content presentation system comprising:
a content presentation device including:
an obtaining unit configured to obtain first preference information indicating a preference of a first user, second preference information indicating a preference of a second user, content identification information identifying a plurality of content items associated with the second user, and relationship information indicating a relationship between the first user and the second user;
a content evaluating unit configured to evaluate display of the content items identified by the content identification information, based on the relationship information and a preference correlation between the preference indicated by the first preference information and the preference indicated by the second preference information; and
an output unit configured to output evaluation information indicating a result of the evaluation performed by the content evaluating unit,
wherein the content evaluating unit is configured to give a high evaluation to at least one of the content items associated with the second user, the at least one content item having the preference correlation lower than a certain preference correlation and an affinity score higher than a certain affinity score, and the affinity score indicating strength of the relationship between the first user and the second user indicated by the relationship information; and
a content presentation terminal including:
a receiving unit configured to receive the evaluation information from the output unit of the content presentation device; and
a display unit configured to display the at least one content item along a preference axis indicating strength of the preference correlation with the first user, based on the evaluation information.

13. The content presentation system according to claim 12,
wherein the output unit is configured to transmit, to the content presentation terminal, the relationship information obtained by the obtaining unit, in addition to the evaluation information,
the receiving unit is configured to receive the evaluation information and the relationship information from the output unit of the content presentation device, and
the display unit is configured to place display of the second user in a display region defined by the preference axis and an affinity axis indicating the affinity score with the first user.

14. A non-transitory computer-readable recording medium, the recording medium having a content presentation program recorded thereon for causing a computer to evaluate display of a content item,
wherein the content presentation program includes:
obtaining first preference information indicating a preference of a first user, second preference information indicating a preference of a second user, content identification information identifying a plurality of content items associated with the second user, and relationship information indicating a relationship between the first user and the second user;
evaluating display of each of the content items identified by the content identification information, based on the relationship information and a preference correlation between the preference indicated by the first preference information and the preference indicated by the second preference information; and
outputting evaluation information indicating a result of the evaluation performed in the evaluating,
wherein in the evaluating, at least one of the content items associated with the second user is given to a high evaluation, the at least one content item having the preference correlation lower than a certain preference correlation and an affinity score higher than a certain affinity score, and the affinity score indicating strength of the relationship between the first user and the second user indicated by the relationship information.

15. A content presentation method comprising:
obtaining first preference information indicating a preference of a first user, second preference information indicating a preference of a second user, content identification information identifying a plurality of content items associated with the second user, and relationship information indicating a relationship between the first user and the second user;
evaluating display of each of the content items identified by the content identification information, based on the relationship information and a preference correlation between the preference indicated by the first preference information and the preference indicated by the second preference information; and
outputting evaluation information indicating a result of the evaluation performed in the evaluating,
wherein in the evaluating, at least one of the content items associated with the second user is given to a high evaluation, the at least one content item having the preference correlation lower than a certain preference correlation and an affinity score higher than a certain affinity score, and the affinity score indicating strength of the relationship between the first user and the second user indicated by the relationship information.
